(19) United States
(12) Patent Application Publication
(10) Pub. No.: US 2019/0147264 A1
(43) Pub. Date: May 16, 2019

(54) CONCENTRATION DETERMINATION APPARATUS, CONCENTRATION DETERMINATION METHOD, AND PROGRAM FOR CONCENTRATION DETERMINATION

(71) Applicant: OMRON Corporation, Kyoto-shi (JP)

(72) Inventors: Hatsumi AOI, Kyotanabe-shi (JP); Tomoyoshi AIZAWA, Kyoto-shi (JP); Tadashi HYUGA, Hirakata-shi (JP)

(73) Assignee: OMRON Corporation, Kyoto-shi (JP)

(21) Appl. No.: 16/131,399

(22) Filed: Sep. 14, 2018

(30) Foreign Application Priority Data
Nov. 15, 2017 (JP) 2017-220023

(51) Int. Cl. G06K 9/00; B60Q 9/00

(52) U.S. Cl. CPC G06K 9/00845; B60Q 9/00; G06K 9/00791

(57) ABSTRACT

A concentration determination apparatus compares a degree of concentration on driving with a first criterion when a location of a traveling vehicle is within a first area different from a dangerous area, and compares the degree of concentration on driving with a second criterion higher than the first criterion when the location of the traveling vehicle is within a second area corresponding to the dangerous area, and outputs an instruction signal for supporting the driver when the location of the traveling vehicle is within the second area and the degree of concentration on driving does not satisfy the second criterion.

### CROSS-REFERENCE TO RELATED APPLICATION

This application claims priority to Japanese Patent Application No. 2017-220023 filed on Nov. 15, 2017, the entire disclosure of which is incorporated herein by reference.

### FIELD

The disclosure relates to a concentration determination apparatus that determines the degree of concentration of a vehicle driver on driving, a concentration determination method, and a program for concentration determination.

### BACKGROUND

Techniques have been developed to determine the driving state of a driver based on the gaze of the driver, and output an alert in accordance with the determined driving state, as one such technique is described in Patent Literature 1.

The technique described in Patent Literature 1 appropriately alerts a driver for a preceding vehicle by lowering an alert to the preceding vehicle for the driver overattentive to the preceding vehicle and lowering alerts to objects other than the preceding vehicle for the driver underattentive to the preceding vehicle.

### CITATION LIST

### Patent Literature

Patent Literature 1: Japanese Unexamined Patent Application Publication No. 2007-73011

### SUMMARY

### Technical Problem

When a vehicle travels in a dangerous area including, for example, a railroad crossing, the driver desirably checks the surroundings more thoroughly than during usual driving. For example, the driver checks for any train approaching the railroad crossing.

However, the technique described in Patent Literature 1, which lowers alerts in accordance with the driver's conditions, may not appropriately alert the driver during traveling in a dangerous area.

One or more aspects are directed to a technique for appropriately supporting a driver during traveling in a dangerous area.

### Solution to Problem

A concentration determination apparatus according to a first aspect of the disclosure includes a monitoring data obtaining unit that obtains monitoring data about a driver of a vehicle, an estimation unit that estimates a degree of concentration of the driver on driving based on the monitoring data, a determiner that determines whether a location of the traveling vehicle is within a dangerous area, a comparison unit that compares the degree of concentration on driving with a first criterion when the location of the traveling vehicle is within a first area different from the dangerous area, and compares the degree of concentration on driving with a second criterion higher than the first criterion when the location of the traveling vehicle is within a second area corresponding to the dangerous area, and an output unit that outputs an instruction signal for supporting the driver when the location of the traveling vehicle is within the second area and the degree of concentration on driving does not satisfy the second criterion based on a determination result from the determiner and a comparison result from the comparison unit.

The concentration determination apparatus according to a first aspect prompts the driver to have a higher degree of concentration on driving than usual while the vehicle is traveling in a dangerous area. Additionally, when the degree of concentration of the driver on driving does not satisfy the second criterion during traveling in the dangerous area, the concentration determination apparatus can appropriately support the driver. Thus, the driver can safely drive the vehicle while maintaining a high degree of concentration on driving within a dangerous area that takes greater concentration and attention than usual.

A concentration determination apparatus according to a second aspect of the disclosure is the concentration determination apparatus according to a first aspect in which when the location of the traveling vehicle is within a third area immediately preceding the second area in a traveling direction of the vehicle, the comparison unit compares the degree of concentration on driving with a third criterion higher than the first criterion and lower than the second criterion. When the location of the traveling vehicle is within the third area and the degree of concentration on driving does not satisfy the third criterion, the output unit outputs the instruction signal before the vehicle reaches the second area.

The concentration determination apparatus according to a second aspect prompts the driver to increase the degree of concentration on driving as the vehicle approaches a dangerous area. Thus, the driver can maintain a higher degree of concentration on driving than usual before the vehicle enters the dangerous area, and prepare for safe driving within the dangerous area.

A concentration determination apparatus according to a third aspect of the disclosure is the concentration determination apparatus according to a first or second aspect in which the second criterion includes a criterion for a predetermined daytime period and a criterion for a predetermined nighttime period higher than the criterion for the predetermined daytime period. The comparison unit compares the degree of concentration on driving with the criterion for the predetermined daytime period when a current date and time is within the predetermined daytime period, and compares the degree of concentration on driving with the criterion for the predetermined nighttime period when the current date and time is within the predetermined nighttime period.

The concentration determination apparatus according to a third aspect prompts the driver to have a higher degree of concentration on driving in the predetermined nighttime period than in the predetermined daytime period while the vehicle is traveling in a dangerous area. Thus, the driver can safely drive the vehicle while maintaining a high degree of concentration on driving in the night with visibility poorer than in the daytime.

A concentration determination apparatus according to a fourth aspect of the disclosure is the concentration determination apparatus according to a first or second aspect of the disclosure in which the second criterion includes a criterion for weekdays and a criterion for Saturdays, Sundays, and holidays higher than the criterion for weekdays. The comparison unit compares the degree of concentration on driving with the criterion for weekdays when a current date and time is within a weekday, and compares the degree of concentration on driving with the criterion for Saturdays, Sundays, and holidays when the current date and time is within any one of Saturday, Sunday, and a holiday.

The concentration determination apparatus according to a fourth aspect prompts the driver to have a higher degree of concentration on driving on Saturdays, Sundays, and holidays than on weekdays while the vehicle is traveling in a dangerous area. Thus, the driver can safely drive the vehicle while maintaining a high degree of concentration on driving on Saturdays, Sundays, and holidays with vehicle and pedestrian traffic heavier than on weekdays.

A concentration determination apparatus according to a fifth aspect of the disclosure is the concentration determination apparatus according to a first or second aspect in which the second criterion includes a plurality of criteria for degrees of congestion around the vehicle. The comparison unit compares the degree of concentration on driving with one of the criteria included in the second criterion in accordance with a degree of congestion around the vehicle.

The concentration determination apparatus according to a fifth aspect prompts the driver to have a degree of concentration on driving in accordance with the degree of congestion around the vehicle while the vehicle is traveling in a dangerous area. Thus, the driver can safely drive the vehicle while maintaining a high degree of concentration on driving in the surroundings with a higher degree of congestion.

A concentration determination apparatus according to a sixth aspect of the disclosure is the concentration determination apparatus according to any one of first to fifth aspects further including a map data obtaining unit that obtains map data including road environment information, and an identification unit that identifies the dangerous area based on the road environment information included in the map data.

The concentration determination apparatus according to a sixth aspect can refer to the road environment information included in the map data to identify every dangerous area. Thus, the driver can safely drive the vehicle in various dangerous areas while maintaining a high degree of concentration on driving.

A concentration determination apparatus according to a seventh aspect of the disclosure is the concentration determination apparatus according to a sixth aspect in which the dangerous area includes at least one of an area including a railroad crossing, an area including a sharp curve, an area including a junction, an area including an intersection with poor visibility, an area including a road section without a boundary marking between a sidewalk and a roadway, and an area including a road section with heavy pedestrian traffic.

The concentration determination apparatus according to a seventh aspect can identify at least one of an area including a railroad crossing, an area including a sharp curve, an area including a junction, an area including an intersection with poor visibility, an area including a road section without a boundary marking between the sidewalk and the roadway, and an area including a road section with heavy pedestrian traffic, as a dangerous area. Thus, the driver can safely drive the vehicle while maintaining a high degree of concentration on driving in such an area that particularly needs safe driving.

A concentration determination apparatus according to an eighth aspect of the disclosure includes the concentration determination apparatus according to any one of first to fifth aspects further including a map data obtaining unit that obtains map data including predefined information indicating a location of the dangerous area, and an identification unit that identifies the dangerous area based on the information included in the map data and indicating the location of the dangerous area.

The concentration determination apparatus according to an eighth aspect can identify a dangerous area based on the predefined information. Thus, the driver can safely drive the vehicle while maintaining a high degree of concentration on driving within an area predefined by the driver as a dangerous area.

A concentration determination apparatus according to a ninth aspect of the disclosure includes the concentration determination apparatus according to any one of first to fifth aspects further including an exterior image data obtaining unit that obtains exterior image data representing a captured exterior view from the vehicle, and an identification unit that identifies the dangerous area based on the exterior image data.

The concentration determination apparatus according to a ninth aspect can refer to the exterior image data to identify a dangerous area in real time within an area not identified in advance as a dangerous area. Thus, the driver can safely drive the vehicle while maintaining a high degree of concentration on driving within a dangerous area identified in real time.

A concentration determination method according to a tenth aspect of the disclosure includes obtaining monitoring data about a driver of a vehicle, estimating a degree of concentration of the driver on driving based on the monitoring data, determining whether a location of the traveling vehicle is within a dangerous area, comparing the degree of concentration on driving with a first criterion when the location of the traveling vehicle is within a first area different from the dangerous area, and comparing the degree of concentration on driving with a second criterion higher than the first criterion when the location of the traveling vehicle is within a second area corresponding to the dangerous area, and outputting an instruction signal for supporting the driver when the location of the traveling vehicle is within the second area and the degree of concentration on driving does not satisfy the second criterion.

The concentration determination method according to a tenth aspect can achieve the same advantageous effects as the concentration determination apparatus according to a first aspect.

A program for concentration determination according to an eleventh aspect of the disclosure causes a computer to implement processes performed by the units included in the concentration determination apparatus according to any one of first to ninth aspects.

The program for concentration determination according to the eleventh aspect can achieve the same advantageous effects as the concentration determination apparatus according to a first aspect.

### Advantageous Effects

One or more aspects provide a technique for appropriately supporting a driver during traveling in a dangerous area.

### BRIEF DESCRIPTION OF THE DRAWINGS

FIG. 1 is a schematic diagram illustrating an example use of a concentration determination apparatus according to one or more embodiments.

FIG. 2 is a schematic diagram illustrating an overall structure of a vehicle including a concentration determination apparatus according to one or more embodiments.

FIG. 3 is a block diagram illustrating a hardware configuration of a concentration determination apparatus according to one or more embodiments.

FIG. 4 is a block diagram illustrating a software configuration of a concentration determination apparatus according to one or more embodiments.

FIG. 5 is a schematic diagram illustrating areas for determining the degree of concentration on driving according to one or more embodiments.

FIG. 6 is a flowchart illustrating an example operation for determining the degree of concentration on driving according to one or more embodiments.

FIG. 7 is a schematic diagram illustrating areas for determining the degree of concentration on driving according to a modification of one or more embodiments.

FIG. 8 is a flowchart illustrating an example operation for determining the degree of concentration on driving according to a modification of one or more embodiments.

### DETAILED DESCRIPTION

One or more embodiments of the present disclosure (hereafter, one or more embodiments) will now be described with reference to the drawings. One or more embodiments described below is a mere example in any aspect. The same or similar components as already described are given the same or similar reference numerals, and will not be described repeatedly.

### 1. EXAMPLE USE

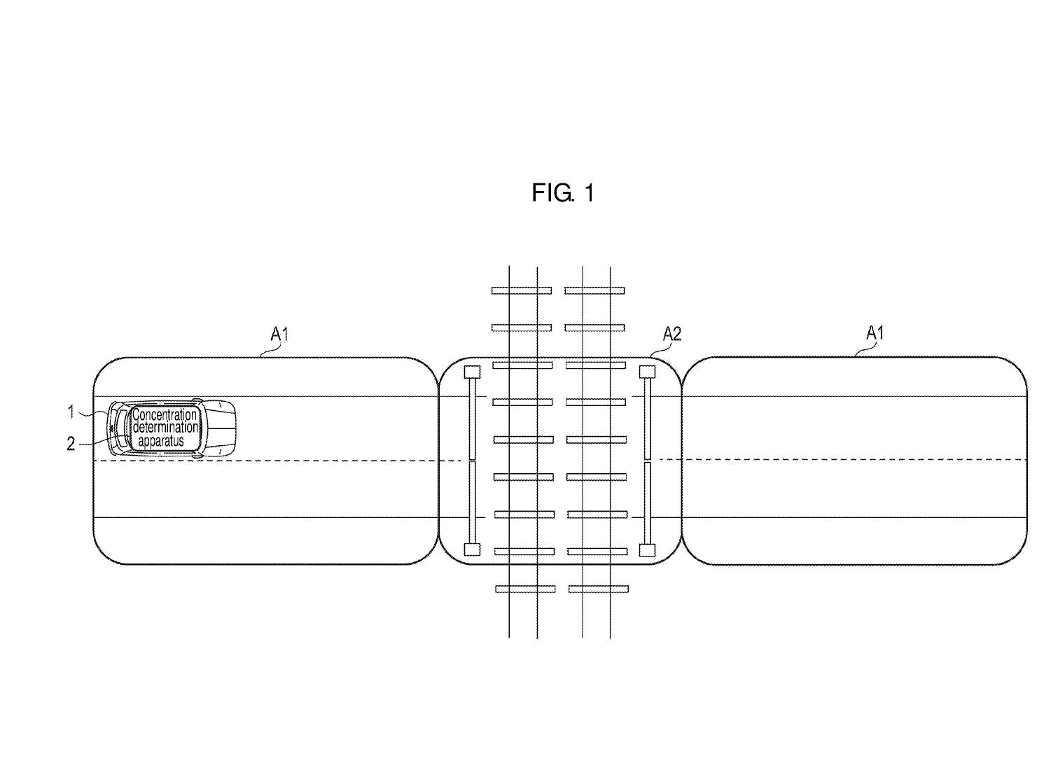

FIG. 1 is a schematic diagram showing an example use of a concentration determination apparatus 2 according to one or more embodiments. A vehicle 1 includes the concentration determination apparatus 2. The concentration determination apparatus 2 virtually divides the road to be traveled by the vehicle 1 into a first area A1 and a second area A2. The first area A1 is an area different from the second area A2. The second area A2 is, for example, a dangerous area such as an area including a railroad crossing.

When the location of the traveling vehicle 1 is within the first area A1, the concentration determination apparatus 2 compares the degree of concentration on driving with a first criterion. When the location of the traveling vehicle 1 is within the first area A1 and the degree of concentration on driving does not satisfy the first criterion, the concentration determination apparatus 2 outputs an instruction signal associated with an alert to the driver.

When the location of the traveling vehicle 1 is within the second area A2, the concentration determination apparatus 2 compares the degree of concentration on driving with a second criterion higher than the first criterion. When the location of the traveling vehicle 1 is within the second area A2 and the degree of concentration on driving does not satisfy the second criterion, the concentration determination apparatus 2 outputs an instruction signal associated with an alert to the driver.

In this manner, the concentration determination apparatus 2 appropriately supports the driver during traveling in a dangerous area.

### 2. STRUCTURE

### Vehicle

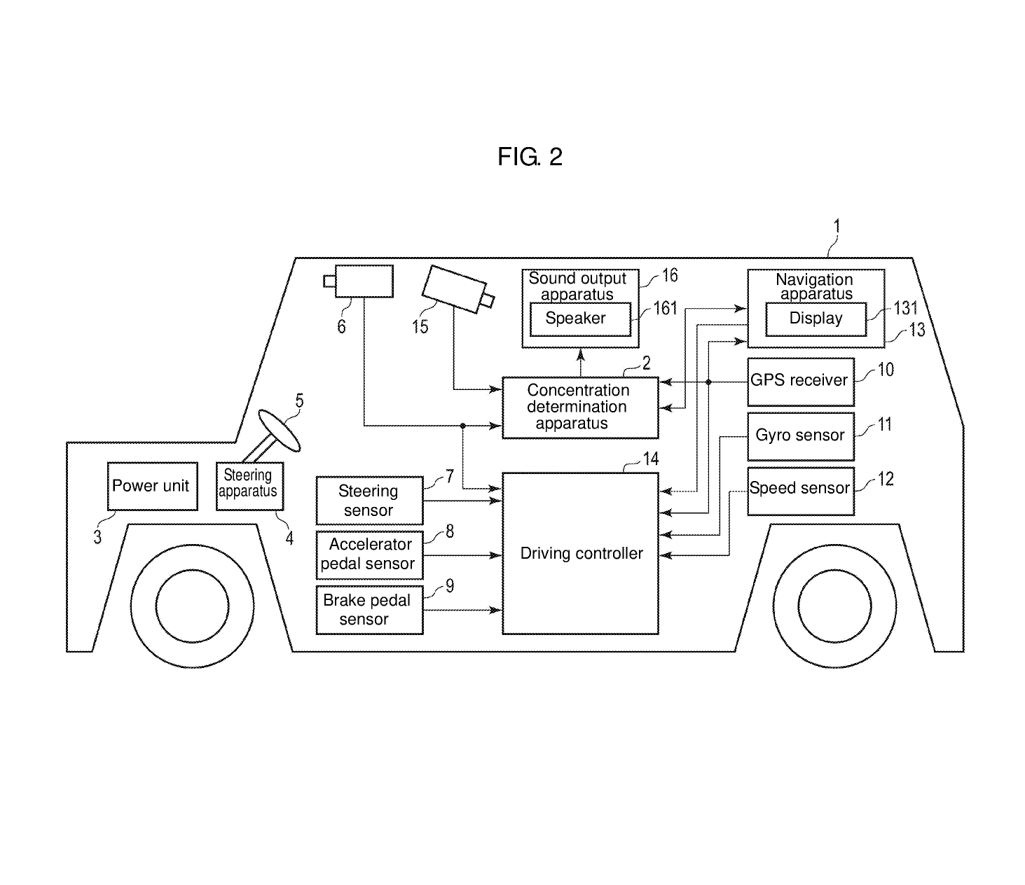

FIG. 2 is a schematic diagram showing the vehicle 1 including the concentration determination apparatus 2 according to one or more embodiments showing its overall structure. The vehicle 1 may be any of, for example, an automobile, a bus, a truck, or a train or may be any other vehicle drivable by a driver.

The vehicle 1 travels in a manual drive mode or an automatic drive mode.

The manual drive mode allows the vehicle 1 to travel based on, for example, the driver's manual driving operation. For example, the manual drive mode includes an operational mode that allows the vehicle 1 to travel based on the driver's driving operation alone, and an operational mode that allows driving operation support control for supporting the driver's driving operation based on the driver's driving operation. For example, when the vehicle 1 travels along a curve, the driving operation support control assists in the steering torque to achieve an appropriate steering quantity by the driver based on the curvature of the curve. The driving operation support control also includes control for supporting the driver's acceleration (e.g., accelerator pedal operation) or the braking (e.g., brake pedal operation). The driving operation support control does not include control that intervenes forcibly in the driver's driving operation to cause the vehicle 1 to travel automatically.

The automatic drive mode enables, for example, the vehicle 1 to travel automatically along the road to be traveled by the vehicle 1. The automatic drive mode may not enable the vehicle 1 to be automatically controlled entirely, but include an operational mode that permits the driver's driving operation to affect the traveling of the vehicle 1 within a predefined allowable range.

The vehicle 1 includes the concentration determination apparatus 2, a power unit 3, a steering apparatus 4, a steering wheel 5, an exterior view camera 6, a steering sensor 7, an accelerator pedal sensor 8, a brake pedal sensor 9, a global positioning system (GPS) receiver 10, a gyro sensor 11, a speed sensor 12, a navigation apparatus 13, a driving controller 14, a driver camera 15, and a sound output apparatus 16.

The concentration determination apparatus 2 determines the degree of concentration of the driver on driving to determine whether the driver is in a condition appropriate for driving the vehicle 1. The degree of concentration on driving is the appropriateness of the driver's conditions for driving the vehicle 1. As the degree of concentration on driving increases, the driver's conditions are more appropriate for driving the vehicle 1. As the degree of concentration on driving decreases, the driver's conditions are less appropriate for driving the vehicle 1. The structure of the concentration determination apparatus 2 will be described later.

The power unit 3 includes a power source and a transmission. The power source includes an engine or a motor or both.

The steering apparatus 4 changes the traveling direction of the vehicle 1.

The steering wheel 5 is connected to the steering apparatus 4. The steering wheel 5 is operated by the driver to change the traveling direction of the vehicle 1.

The exterior view camera 6 captures an image of the exterior of the vehicle 1. For example, the exterior view camera 6 constantly captures images in front of the vehicle 1. The exterior view camera 6 outputs the captured images of the exterior of the vehicle 1 (hereafter, exterior image data) to the concentration determination apparatus 2 and the driving controller 14. The exterior view camera 6 is installed at a given position of the vehicle 1. Although FIG. 1 shows the single exterior view camera 6, the vehicle 1 may include multiple exterior view cameras 6 for capturing views in different directions.

The steering sensor 7 detects a steering angle. The steering sensor 7 outputs the detection result to the driving controller 14.

The accelerator pedal sensor 8 detects an operational quantity of an accelerator pedal. The accelerator pedal sensor 8 outputs the detection result to the driving controller 14.

The brake pedal sensor 9 detects an operational quantity of a brake pedal. The brake pedal sensor 9 outputs the detection result to the driving controller 14.

The GPS receiver 10 receives GPS signals transmitted from multiple GPS satellites, and calculates the current location of the vehicle 1 based on the GPS signals. The GPS receiver 10 outputs information indicating the current location (hereafter, current location information) to the concentration determination apparatus 2, the navigation apparatus 13, and the driving controller 14.

The gyro sensor 11 detects the behavior of the vehicle 1. The gyro sensor 11 outputs the detection result to the driving controller 14.

The speed sensor 12 detects the speed of the vehicle 1. The speed sensor 12 outputs the detection result to the driving controller 14.

The navigation apparatus 13 is an example of an image display device including a display 131 for displaying an image. The navigation apparatus 13 stores map data. The map data includes information about the features of roads as described below. The information about the features of roads includes road width information, information indicating the number of traffic lanes, road type information indicating an expressway, an ordinary road, and other roads, and information indicating a boundary marking between a sidewalk and a roadway. In addition to such information about road features, the map data includes various items of road environment information as described below. The map data may include information indicating the location of a railroad crossing. The map data may include information indicating the location of a curve section and information indicating the curvature of a curve section. The map data may include information indicating the location of a junction. The map data may include information indicating the location of an intersection. The map data may include information indicating the location of a building near a road and information indicating the features of a building. Examples of the features of a building include a size and a shape.

The navigation apparatus 13 uses information about a destination input by, for example, the driver, the map data, and the current location information from the GPS receiver 10 to extract information about routes from the current location to the destination. The navigation apparatus 13 displays the route information on the display 131. The navigation apparatus 13 displays information other than the route information on the display 131. The navigation apparatus 13 outputs the map data to the concentration determination apparatus 2. The navigation apparatus 13 outputs the route information to the driving controller 14.

The structure of the driving controller 14 will now be described. The driving controller 14 controls the traveling of the vehicle 1. The driving controller 14 obtains the exterior image data from the exterior view camera 6, the detection result from the steering sensor 7, the detection result from the accelerator pedal sensor 8, the detection result from the brake pedal sensor 9, the current location information from the GPS receiver 10, the detection result from the gyro sensor 11, the detection result from the speed sensor 12, and the route information from the navigation apparatus 13. The driving controller 14 uses these items of information to control the traveling of the vehicle 1. In addition to these information items, the driving controller 14 may use traffic information obtained via at least one of road-to-vehicle communication and inter-vehicle communication to control the traveling of the vehicle 1.

In the automatic drive mode, the driving controller 14 automatically controls the traveling of the vehicle 1. The automatic control includes, for example, autosteering (automatic steering during driving) and automatic speed regulation (automatic speed control during driving). The autosteering enables a driving state in which the steering apparatus 4 is automatically controlled. The autosteering includes a lane keeping assist system (LKAS). For example, the LKAS automatically controls the steering apparatus 4 to prevent the vehicle 1 from leaving the driving lane without the driver's driving operation. When the LKAS is enabled, the driving controller 14 may permit the driver's driving operation to affect the steering of the vehicle 1 without the vehicle 1 leaving the driving lane (within an allowable range). The autosteering is not limited to the LKAS.

The automatic speed regulation enables a driving state in which the speed of the vehicle 1 is automatically controlled. The automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs follow-up control to regulate the speed of the vehicle 1 in accordance with the distance from the preceding vehicle. When ACC is enabled, the driving controller 14 reduces the speed of the vehicle 1 in response to the driver's braking (e.g., brake pedal operation). When ACC is enabled, the driving controller 14 may also accelerate the vehicle 1 in accordance with the driver's acceleration (e.g., accelerator pedal operation) up to the predefined maximum permissible speed (e.g., the legally defined maximum speed on the road being traveled). The automatic speed regulation may not be ACC but may be cruise control (CC).

The structure of the driver camera 15 will now be described. The driver camera 15 constantly captures images of a predefined range including the face of the driver. The driver camera 15 is installed in front of the driver, for example, on a dashboard. The driver camera 15 is an example of a sensor for monitoring the driver. The driver camera 15 captures images (hereafter, driver image data) and outputs the data to the concentration determination apparatus 2. The driver image data is an example of monitoring data used to estimate the degree of concentration of the driver on driving.

The driver's conditions include, for example, at least one of indicators such as the driver's looking carefully in the forward direction, feeling drowsy, looking aside, putting on or taking off clothes, operating a phone, leaning against the window or an armrest, receiving interference in driving from a passenger or a pet, suffering a disease attack (e.g. sudden onset of disease or illness, such as a heart attack), looking back, resting the head on the arms, eating and drinking, smoking, feeling dizzy, taking abnormal action, operating the car navigation or the audio, putting on or taking off glasses or sunglasses, and taking a photograph. The driver's conditions may include indicators other than these examples.

The sound output apparatus 16 includes a speaker 161. The sound output apparatus 16 outputs various items of information using sounds.

Concentration Determination Apparatus Hardware Configuration

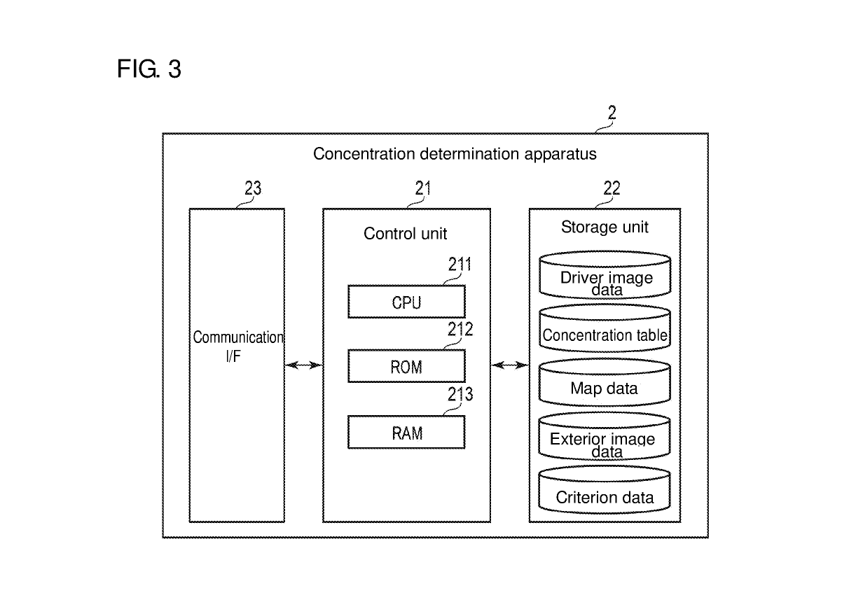

FIG. 3 is a block diagram of the concentration determination apparatus 2 according to one or more embodiments showing its hardware configuration. The concentration determination apparatus 2 includes a control unit 21, a storage unit 22, and a communication interface 23, which are electrically connected to one another. In FIG. 3, the communication interface is abbreviated as the communication I/F.

The control unit 21 will now be described. The control unit 21 controls the operation of each unit in the concentration determination apparatus 2. The control unit 21 includes a central processing unit (CPU) 211, a read only memory (ROM) 212, and a random access memory (RAM) 213. The CPU 211 is an example of a processor. The CPU 211 expands, in the RAM 213, programs stored in the storage unit 22 for implementing the concentration determination apparatus 2. The CPU 211 then interprets and executes the programs expanded in the RAM 213. This allows the control unit 21 to implement the function of each unit in the software configuration described later.

The storage unit 22 will now be described. The storage unit 22 is an auxiliary storage device. The storage unit 22 may be, but is not limited to, a hard disk drive (HDD). The storage unit 22 stores programs executable by the control unit 21. The programs enable the concentration determination apparatus 2 to function as each unit in the software configuration described later. The programs may be prestored in the storage unit 22, or may be downloaded to the concentration determination apparatus 2 through a network. The programs may be stored in a non-transitory computer-readable medium, such as a ROM, and distributed.

The storage unit 22 stores data used by the control unit 21 as described below. The storage unit 22 stores driver image data obtained from the driver camera 15 to the control unit 21. For example, the control unit 21 obtains the driver image data from the driver camera 15 at predetermined intervals and stores the data into the storage unit 22.

The storage unit 22 stores a concentration table. The concentration table is used by the control unit 21 to estimate the degree of concentration on driving as described later. The concentration table associates the driver's conditions for each indicator with different levels in accordance with the degree of concentration on driving. This example uses, but is not limited to, three levels: level 1, level 2, and level 3. A level with a larger number herein indicates, but is not limited to, a lower degree of concentration on driving. A level with a larger number may indicate a higher degree of concentration on driving.

The information managed in the concentration table will now be described by taking looking aside as an example. For looking aside as one indicator, the concentration table associates the driver's conditions with level 1, level 2, and level 3 as described below. For example, level 1 corresponds to the condition of the driver looking in a direction inclined at an angle between 0 degrees or more and less than a first angle to the traveling direction of the vehicle 1. More specifically, level 1 indicates that the driver is not looking aside and has a high degree of concentration on driving. Level 2, for example, corresponds to the condition of the driver looking in a direction inclined at an angle between the first angle or more and less than a second angle to the traveling direction of the vehicle 1. More specifically, level 2 indicates that the driver is looking aside slightly and has a lower degree of concentration on driving than the driver at level 1. For example, Level 3 corresponds to the condition of the driver looking in a direction inclined at an angle equal to or greater than the second angle to the traveling direction of the vehicle 1. More specifically, level 3 indicates the driver is looking aside and has a lower degree of concentration on driving than the driver at level 2. Although the information managed in the concentration table has been described by taking looking aside as an example, the other indicators have similar relations to the driver's conditions.

The storage unit 22 stores map data. The control unit 21 obtains map data from the navigation apparatus 13, and stores the map data into the storage unit 22. The map data may be prestored in the storage unit 22.

The storage unit 22 stores exterior image data. The control unit 21 obtains, for example, exterior image data from the exterior view camera 6 at predetermined intervals and stores the data into the storage unit 22.

The storage unit 22 stores different criteria for determining the degree of concentration on driving depending on the location of the traveling vehicle 1. For example, the criteria include a first criterion and a second criterion described later.

The communication interface 23 will now be described. The communication interface 23 connects the exterior view camera 6, the GPS receiver 10, the navigation apparatus 13, the driver camera 15, and the sound output apparatus 16 to the control unit 21. The communication interface 23 may include an interface for wired communication or an interface for wireless communication.

For the specific hardware configuration of the concentration determination apparatus 2, components may be eliminated, substituted, or added as appropriate in one or more embodiments. For example, the control unit 21 may include multiple processors.

### Software Configuration

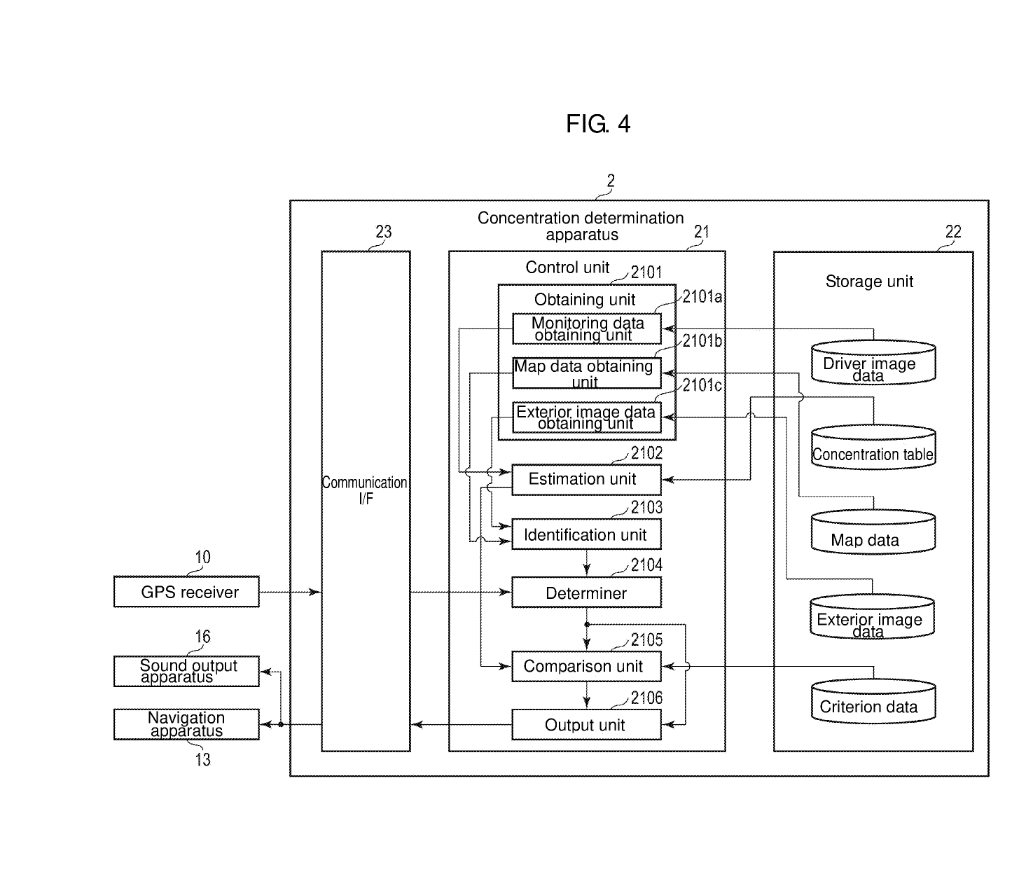

FIG. 4 is a block diagram of the concentration determination apparatus 2 according to one or more embodiments showing its software configuration.

The control unit 21 includes an obtaining unit 2101, an estimation unit 2102, an identification unit 2103, a determiner 2104, a comparison unit 2105, and an output unit 2106.

The obtaining unit 2101 will now be described. The obtaining unit 2101 includes a monitoring data obtaining unit 2101a, a map data obtaining unit 2101b, and an exterior image data obtaining unit 2101c.

The monitoring data obtaining unit 2101a obtains driver image data about the driver of the vehicle 1. In one example, the monitoring data obtaining unit 2101a can obtain driver image data from the storage unit 22 in order of recording date and time. The monitoring data obtaining unit 2101a may obtain driver image data sequentially from the driver camera 15, not from the storage unit 22. The monitoring data obtaining unit 2101a outputs the driver image data to the estimation unit 2102.

The map data obtaining unit 2101b obtains map data including various items of information. In one example, the map data obtaining unit 2101b can obtain map data from the storage unit 22. The map data obtaining unit 2101b may obtain map data from the navigation apparatus 13, not from the storage unit 22. The map data obtaining unit 2101b outputs the map data to the identification unit 2103.

The exterior image data obtaining unit 2101c obtains exterior image data. In one example, the exterior image data obtaining unit 2101c can obtain exterior image data from the storage unit 22 in order of recording date and time. The exterior image data obtaining unit 2101c may obtain exterior image data sequentially from the exterior view camera 6, not from the storage unit 22. The exterior image data obtaining unit 2101c outputs the exterior image data to the identification unit 2103.

The estimation unit 2102 will now be described. The estimation unit 2102 estimates the degree of concentration of the driver on driving based on the driver image data. The estimation unit 2102 can estimate the degree of concentration on driving as a value such as a percentage or a level selected from multiple levels based on the driver image data received from the monitoring data obtaining unit 2101a. The estimation unit 2102 refers to the concentration table to estimate the degree of concentration on driving as a level selected from multiple levels. The operation for estimating the degree of concentration on driving by the estimation unit 2102 will be described later. The estimation unit 2102 outputs the estimation result indicating the degree of concentration on driving to the comparison unit 2105.

The identification unit 2103 will now be described. The identification unit 2103 identifies the location of a dangerous area. The dangerous area is defined as an area where the driver driving the vehicle 1 takes greater concentration and attention than usual. Examples of the usual driving include, but are not limited to, traveling a straight road with a boundary marking between the sidewalk and the roadway. The dangerous area includes, for example, at least one of an area including a railroad crossing, an area including a sharp curve, an area including a junction, an area including an intersection with poor visibility, an area including a road section without a boundary marking between the sidewalk and the roadway, and an area including a road section with heavy pedestrian traffic. The range of the dangerous area may be defined as appropriate. For example, an area including a railroad crossing may be any area including the section between at least two railroad crossing gates. The dangerous area may be an area other than these listed areas, which are examples. In one or more embodiments, a first area A1 is an area different from the dangerous area. A second area A2 is an area corresponding to the dangerous area. The operation for identifying the dangerous area performed by the identification unit 2103 will be described later. The identification unit 2103 outputs the identification result indicating the location of the dangerous area to the determiner 2104.

The determiner 2104 will now be described. The determiner 2104 determines whether the location of the traveling vehicle 1 is within the dangerous area. The determination operation performed by the determiner 2104 will be described later. The determiner 2104 outputs the determination result indicating an area including the location of the traveling vehicle 1 to the comparison unit 2105 and the output unit 2106.

The comparison unit 2105 will now be described. The comparison unit 2105 compares the degree of concentration on driving with the criterion for the location of the traveling vehicle 1 based on the estimation result from the estimation unit 2102 and the determination result from the determiner 2104 as described below. In one or more embodiments, a first criterion is the criterion associated with the first area A1. A second criterion is the criterion associated with the second area A2. The first criterion and the second criterion are stored in the storage unit 22.

When the location of the traveling vehicle 1 is within the first area A1, the comparison unit 2105 compares the degree of concentration on driving with the first criterion. When the location of the traveling vehicle 1 is within the second area A2, the comparison unit 2105 compares the degree of concentration on driving with the second criterion. The second criterion is higher than the first criterion. The second criterion prompts the driver to have a higher degree of concentration on driving than the first criterion. The second criterion is stricter than the first criterion about the degree of concentration on driving. When the estimation unit 2102 estimates the degree of concentration on driving for each of the indicators, the comparison unit 2105 may compare the degree of concentration on driving for each of the indicators with the criterion. The operation for comparing the degree of concentration on driving with the criterion will be described later. The comparison unit 2105 outputs the comparison result to the output unit 2106.

The output unit 2106 will now be described. Based on the determination result from the determiner 2104 and the comparison result from the comparison unit 2105 as described below, the output unit 2106 outputs an instruction signal to a support apparatus to support the driver. When the location of the traveling vehicle 1 is within the first area A1 and the degree of concentration on driving does not satisfy the first criterion, the output unit 2106 outputs the instruction signal. When the location of the traveling vehicle 1 is within the second area A2 and the degree of concentration on driving does not satisfy the second criterion, the output unit 2106 outputs the instruction signal.

The support apparatus may include the navigation apparatus 13 and the sound output apparatus 16. The support apparatus may include, for example, an apparatus that externally stimulates the driver by providing vibrations for example, in addition to the navigation apparatus 13 and the sound output apparatus 16. The support apparatus that has received the instruction signal from the output unit 2106 starts supporting the driver. Supporting the driver includes providing an output that acts on the driver, including an alert, a caution, and notification, and various other forms of support to improve the degree of concentration on driving.

### 3. EXAMPLE OPERATION

### Concentration Determination Apparatus

### Operation for Estimating Degree of Concentration on Driving

The operation for estimating the degree of concentration on driving performed by the estimation unit 2102 will now be described. The estimation unit 2102 first detects the driver's conditions based on image data for the driver. The estimation unit 2102 detects the driver's conditions as described below. The estimation unit 2102 detects the conditions of at least one of the driver's facial parts in the driver image data as local information. The facial parts include, but are not limited to, eyes, a mouth, a nose, and ears. When detecting the ocular state, the estimation unit 2102 detects, for example, the degree of opening of the driver's eyes, the gaze direction, and the face orientation. The estimation unit 2102 detects at least one of the driver's overall conditions in the driver image data. Examples of the overall conditions include, but are not limited to, the driver's movements and posture. The estimation unit 2102 uses such local information and overall information to detect the driver's conditions.

The estimation unit 2102 then continuously estimates the degree of concentration of the driver on driving based on the driver's conditions. The estimation unit 2102 estimates the degree of concentration on driving for each of the indicators in the driver's conditions. The estimation unit 2102 estimates, for example, the degree of concentration on driving for the indicator of feeling drowsy and also the degree of concentration on driving for the indicator of looking aside.

The estimation unit 2102 may also estimate, for example, a single degree of concentration on driving for a collection of multiple indicators in the driver's conditions.

In one example, the estimation unit 2102 can estimate the degree of concentration on driving as a value such as a percentage. The value estimated by the estimation unit 2102 may increase or decrease as the degree of concentration on driving is higher. In another example, the estimation unit 2102 can refer to the concentration table to estimate the degree of concentration on driving as a level selected from multiple levels.

The estimation unit 2102 may estimate the degree of concentration on driving using an artificial intelligence (A1) function, such as machine learning or deep learning. In this case, for example, the estimation unit 2102 can estimate the driver's conditions with high accuracy using the historical estimation results for estimating the current degree of concentration on driving.

### Operation for Identifying Dangerous Area

The operation for identifying a dangerous area performed by the identification unit 2103 will now be described. The identification unit 2103 first identifies a dangerous area as described below.

In one example, the identification unit 2103 identifies a dangerous area based on the road environment information included in the map data as described below. The identification unit 2103 first receives the map data from the map data obtaining unit 2101b. The map data includes the road environment information. The identification unit 2103 then identifies a dangerous area based on the road environment information included in the map data. The identification unit 2103 can refer to information indicating the location of a railroad crossing, and identify an area within a predetermined distance from the location of the railroad crossing as a dangerous area. The identification unit 2103 can refer to information indicating the location of a curve section and information indicating the curvature of a curve section to identify a curve section having a predetermined curvature or greater, and identify an area within a predetermined distance from the location of the curve section having the predetermined curvature or greater (sharp curve section) as a dangerous area. The identification unit 2103 can refer to information indicating the location of a junction, and identify an area within a predetermined distance from the location of the junction as a dangerous area. The identification unit 2103 can refer to information indicating the location of an intersection, information indicating the location of a building near a road, and information indicating the features of a building to identify an intersection with poor visibility, and identify an area within a predetermined distance from the location of the intersection with poor visibility as a dangerous area. The identification unit 2103 can refer to information about the features of roads to identify a road section without a boundary marking between the sidewalk and the roadway, and identify an area including the road section without a boundary marking between the sidewalk and the roadway as a dangerous area.

The identification unit 2103 can refer to information indicating the location of a building near a road to identify an area including a road section with heavy pedestrian traffic. For example, the identification unit 2103 can refer to information indicating the location of a station to identify an area within a predetermined radius from the location of the station as an area including a road section with heavy pedestrian traffic. The identification unit 2103 can refer to, for example, information indicating the location of a stadium to identify an area within a predetermined radius from the location of the stadium as an area including a road section with heavy pedestrian traffic. These areas are examples, and the area including a road section with heavy pedestrian traffic is not limited to an area within a predetermined radius from the location of a station or the location of a stadium.

In another example, the identification unit 2103 identifies a dangerous area based on information indicating the location of a dangerous area predefined on the map data as described below. The identification unit 2103 first receives the map data from the map data obtaining unit 2101b. The map data includes predefined information indicating the location of a dangerous area. The identification unit 2103 then extracts the predefined information indicating the location of the dangerous area from the map data. The identification unit 2103 can identify a dangerous area based on the information indicating the location of the dangerous area extracted from the map data. The location of a dangerous area may be predefined freely. For example, the driver can choose an area that takes concentration and attention from the roads used frequently, and predefine the area as a dangerous area.

In still another example, the identification unit 2103 identifies a dangerous area based on the exterior image data as described below. The identification unit 2103 first receives the exterior image data from the exterior image data obtaining unit 2101c. The identification unit 2103 then analyzes the exterior image data. The identification unit 2103 can extract, for example, a railroad crossing, a junction, and a road without a boundary marking between the sidewalk and the roadway from the exterior image data. The identification unit 2103 can extract, for example, a sharp curve having a predetermined curvature or greater from the exterior image data. The identification unit 2103 can analyze, for example, the positional relationship between a road and a building, and extract an intersection with poor visibility below a predetermined criterion from the exterior image data. For example, the identification unit 2103 can count people walking on roads, and extract a road with heavy pedestrian traffic below a predetermined criterion from the exterior image data. The predetermined criterion may be the number or the density of people. The predetermined criterion may vary depending on, for example, the road width and the number of lanes. The identification unit 2103 can identify an area within a predetermined distance from the location of the railroad crossing or other section extracted from the exterior image data as a dangerous area.

The identification unit 2103 outputs the identification result indicating the location of the dangerous area identified as described above to the determiner 2104.

### Operation for Determining Dangerous Area

The operation for determining whether the location of the traveling vehicle 1 is within the dangerous area performed by the determiner 2104 will now be described. The determiner 2104 first receives the identification result indicating the location of the dangerous area from the identification unit 2103. Based on the received result, the determiner 2104 virtually divides the road to be traveled by the vehicle 1 into a first area A1 different from the dangerous area and a second area A2 corresponding to the dangerous area.

Based on the current location information and the information indicating the location of the dangerous area, the determiner 2104 then compares the current location of the vehicle 1 with the location of the dangerous area. In this comparison, the determiner 2104 determines whether the location of the traveling vehicle 1 is within the dangerous area. When the location of the traveling vehicle 1 is outside the dangerous area, the determiner 2104 determines that the location of the traveling vehicle 1 is within the first area A1. When the location of the traveling vehicle 1 is within the dangerous area, the determiner 2104 determines that the location of the traveling vehicle 1 is within the second area A2.

The determiner 2104 outputs the determination result indicating an area including the location of the traveling vehicle 1 to the comparison unit 2105 and the output unit 2106. In one example, when determining that the location of the traveling vehicle 1 is within the first area A1, the determiner 2104 outputs the determination result indicating the first area A1 to the comparison unit 2105 and the output unit 2106. In another example, when determining that the location of the traveling vehicle 1 is within the second area A2, the determiner 2104 outputs the determination result indicating the second area A2 to the comparison unit 2105 and the output unit 2106.

Operation for Comparing Degree of Concentration on Driving with Criterion

The operation for comparing the degree of concentration on driving with the criterion by the comparison unit 2105 will now be described. When the location of the traveling vehicle 1 is within the first area A1, the comparison unit 2105 compares the degree of concentration on driving with a first criterion value or a first criterion level that is the first criterion. When the degree of concentration on driving is equal to or greater than the first criterion value or the first criterion level, the comparison unit 2105 determines that the degree of concentration on driving satisfies the first criterion. When the degree of concentration on driving is smaller than the first criterion value or the first criterion level, the comparison unit 2105 determines that the degree of concentration on driving does not satisfy the first criterion.

When the location of the traveling vehicle 1 is within the second area A2, the comparison unit 2105 compares the degree of concentration on driving with a second criterion value or a second criterion level that is the second criterion. When the degree of concentration on driving is equal to or greater than the second criterion value or the second criterion level, the comparison unit 2105 determines that the degree of concentration on driving satisfies the second criterion. When the degree of concentration on driving is smaller than the second criterion value or the second criterion level, the comparison unit 2105 determines that the degree of concentration on driving does not satisfy the second criterion.

The degree of concentration on driving is a numerical value in the example described below. The numerical value indicating the degree of concentration on driving estimated by the estimation unit 2102 is greater as the degree of concentration on driving is higher. The first criterion value is a numerical value A, and the second criterion value is a numerical value B greater than the numerical value A. The second criterion value is greater than the first criterion value.

When the numerical value indicating the degree of concentration on driving estimated by the estimation unit 2102 is equal to or greater than the numerical value A, which is the first criterion value, the comparison unit 2105 determines that the degree of concentration on driving satisfies the first criterion. When the numerical value indicating the degree of concentration on driving estimated by the estimation unit 2102 is smaller than the numerical value A, which is the first criterion value, the comparison unit 2105 determines that the degree of concentration on driving does not satisfy the first criterion.

When the numerical value indicating the degree of concentration on driving estimated by the estimation unit 2102 is equal to or greater than the numerical value B, which is the second criterion value, the comparison unit 2105 determines that the degree of concentration on driving satisfies the second criterion. When the numerical value indicating the degree of concentration on driving estimated by the estimation unit 2102 is smaller than the numerical value B, which is the second criterion value, the comparison unit 2105 determines that the degree of concentration on driving does not satisfy the second criterion.

The degree of concentration on driving is a level in the example described below. In the example described below, the concentration table associates the driver's conditions for each indicator with three levels: level 1, level 2, and level 3 as described above. For example, the first criterion level is level 2, and the second criterion level is level 1 higher than level 2.

Level 1 and level 2 are equal to or higher than level 2, which is the first criterion level. Level 3 is lower than level 2, which is the first criterion level. Thus, when the level indicating the degree of concentration on driving estimated by the estimation unit 2102 is level 1 or level 2, the comparison unit 2105 determines that the degree of concentration on driving satisfies the first criterion. When the level indicating the degree of concentration on driving estimated by the estimation unit 2102 is level 3, the comparison unit 2105 determines that the degree of concentration on driving does not satisfy the first criterion.

Level 1 is equal to or higher than level 1, which is the second criterion level. Level 2 and level 3 are lower than level 1, which is the second criterion level. Thus, when the level indicating the degree of concentration on driving estimated by the estimation unit 2102 is level 1, the comparison unit 2105 determines that the degree of concentration on driving satisfies the first criterion. When the level indicating the degree of concentration on driving estimated by the estimation unit 2102 is level 2 or level 3, the comparison unit 2105 determines that the degree of concentration on driving does not satisfy the first criterion.

### Operation for Determining Concentration on Driving

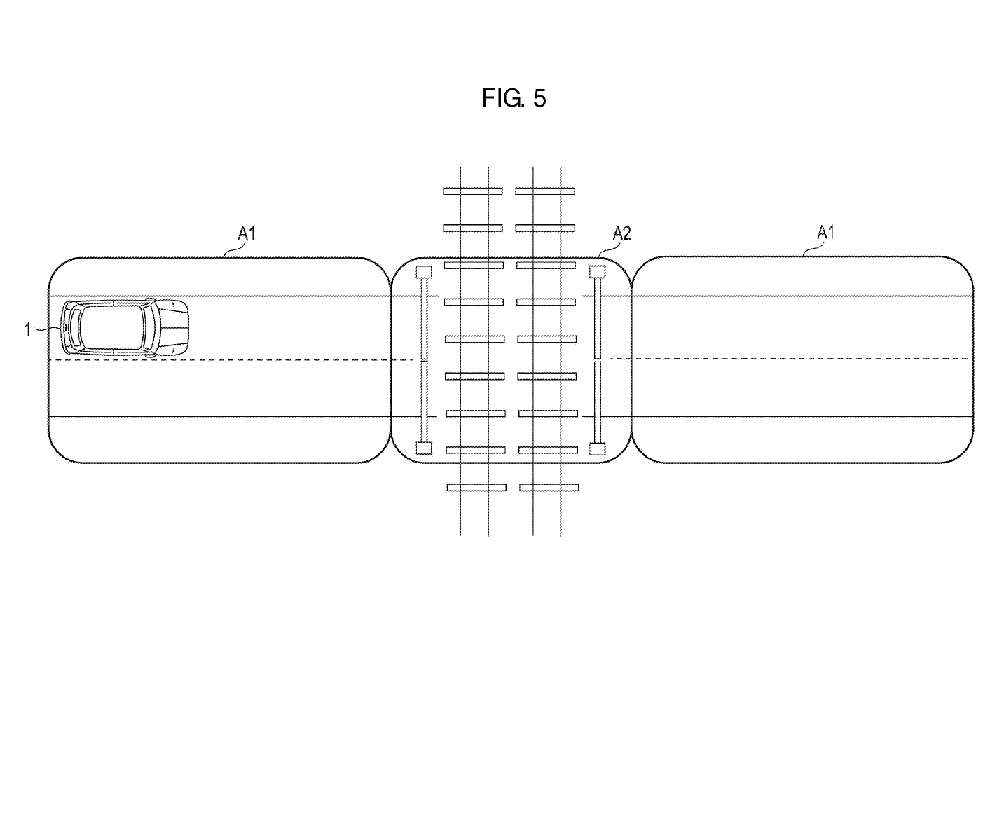

The operation for determining the degree of concentration on driving performed by the concentration determination apparatus 2 will now be described. FIG. 5 is a schematic diagram showing areas for determining the degree of concentration on driving according to one or more embodiments. The concentration determination apparatus 2 virtually divides the road to be traveled by the vehicle 1 into a first area A1 and a second area A2. The first area A1 is an area different from the second area A2. The second area A2 is, for example, a dangerous area such as an area including a railroad crossing. The first area A1 is associated with the first criterion. The second area A2 is associated with the second criterion.

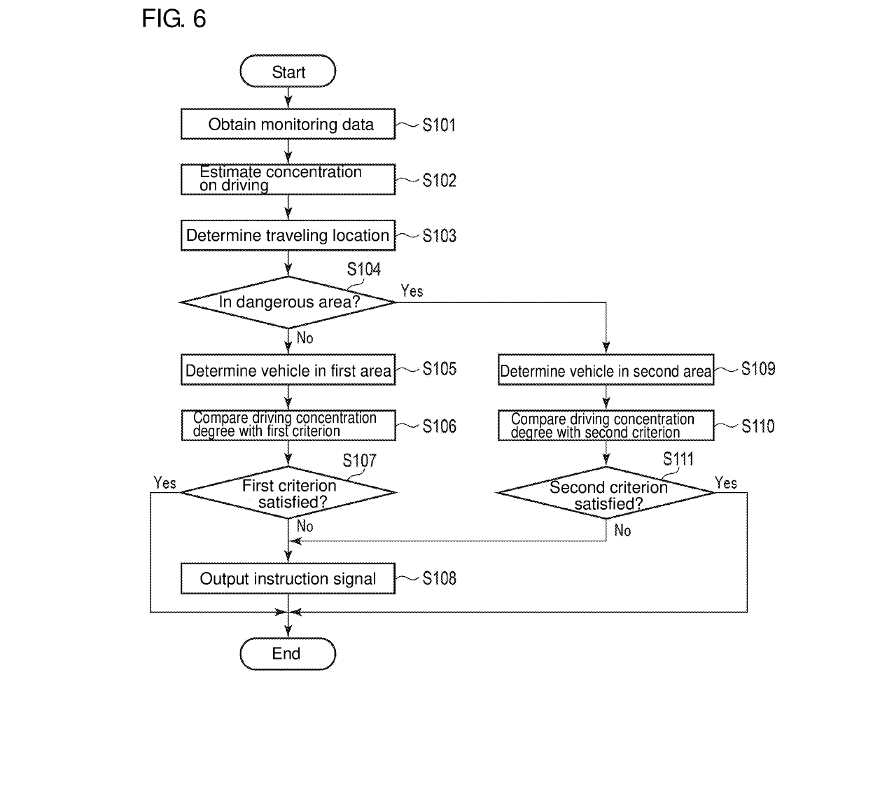

FIG. 6 is a flowchart showing an example operation for determining the degree of concentration on driving according to one or more embodiments. The concentration determination apparatus 2 repeats the operation shown in FIG. 6 for determining the degree of concentration on driving. The concentration determination apparatus 2 may perform the operation shown in FIG. 6 for determining the degree of concentration on driving in the automatic drive mode as well as in the manual drive mode. The procedure described below is a mere example, and each of its processes may be modified. In the procedure described below, steps may be eliminated, substituted, or added as appropriate.

The monitoring data obtaining unit 2101a obtains the driver image data about the driver of the vehicle 1 as described above (step S101).

The estimation unit 2102 estimates the degree of concentration of the driver on driving based on the driver image data as described above (step S102).

The determiner 2104 determines the location of the traveling vehicle 1 as described above (step S103).

The determiner 2104 determines whether the location of the traveling vehicle 1 is within the dangerous area as described above (step S104).

When the location of the traveling vehicle 1 is outside the dangerous area (No in step S104), the determiner 2104 determines that the location of the traveling vehicle 1 is within the first area A1 (step S105). The comparison unit 2105 compares the degree of concentration on driving with the first criterion as described above (step S106). When the degree of concentration on driving satisfies the first criterion (Yes in step S107), the concentration determination apparatus 2 ends the operation for determining the degree of concentration on driving.

When the degree of concentration on driving does not satisfy the first criterion (No in step S107), the output unit 2106 outputs an instruction signal as described above (step S108). More specifically, in step S108, when the location of the traveling vehicle 1 is within the first area A1 and the degree of concentration on driving does not satisfy the first criterion, the output unit 2106 outputs the instruction signal. The concentration determination apparatus 2 ends the operation for determining the degree of concentration on driving after the instruction signal is output.

When the location of the traveling vehicle 1 is within the dangerous area (Yes in step S104), the determiner 2104 determines that the location of the traveling vehicle 1 is within the second area A2 (step S109). The comparison unit 2105 compares the degree of concentration on driving with the second criterion as described above (step S110). When the degree of concentration on driving satisfies the second criterion (Yes in step S111), the concentration determination apparatus 2 ends the operation for determining the degree of concentration on driving.

When the degree of concentration on driving does not satisfy the second criterion (No in step S111), the output unit 2106 outputs an instruction signal as described above (step S108). More specifically, in step S108, when the location of the traveling vehicle 1 is within the second area A2 and the degree of concentration on driving does not satisfy the second criterion, the output unit 2106 outputs the instruction signal. The concentration determination apparatus 2 ends the operation for determining the degree of concentration on driving after the instruction signal is output.

The second criterion may be any criterion higher than the first criterion, and may include multiple criteria set in accordance with the traveling state of the vehicle 1 as described below. In this case, the comparison unit 2105 selects a criterion from the multiple criteria included in the second criterion in accordance with the traveling state of the vehicle 1, and compares the degree of concentration on driving with the selected criterion.

In one example, the second criterion may include a criterion for a predetermined daytime period and a criterion for a predetermined nighttime period higher than the criterion for the predetermined daytime period. The predetermined daytime period and the predetermined nighttime period do not overlap each other.

In this example, the comparison unit 2105 obtains the current date and time from a clock unit (not shown) included in the concentration determination apparatus 2, and determines whether the current date and time is within the predetermined nighttime period or the predetermined daytime period. The comparison unit 2105 compares the degree of concentration on driving with one of the criteria included in the second criterion in accordance with which of the predetermined daytime period and the predetermined nighttime period includes the current date and time. More specifically, when the current date and time is within the predetermined daytime period, the comparison unit 2105 compares the degree of concentration on driving with the criterion for the predetermined daytime period included in the second criterion. When the current date and time is within the predetermined nighttime period, the comparison unit 2105 compares the degree of concentration on driving with the criterion for the predetermined nighttime period included in the second criterion.

In another example, the second criterion may include a criterion for weekdays and a criterion for Saturdays, Sundays, and holidays higher than the criterion for weekdays. In this example, the comparison unit 2105 obtains the current date and time and calendar information stored in the concentration determination apparatus 2, and determines which of a weekday and Saturday, Sunday, or a holiday corresponds to the current date and time. The comparison unit 2105 compares the degree of concentration on driving with one of the criteria included in the second criterion in accordance with which of a weekday and Saturday, Sunday, or a holiday corresponds to the current date and time. More specifically, when the current date and time is within a weekday, the comparison unit 2105 compares the degree of concentration on driving with the criterion for weekdays included in the second criterion. When the current date and time is within any one of Saturday, Sunday, and a holiday, the comparison unit 2105 compares the degree of concentration on driving with the criterion for Saturdays, Sundays, and holidays included in the second criterion.

In still another example, the second criterion may include multiple criteria for the degree of congestion around the vehicle 1 caused by people walking on the road and vehicles traveling on the road other than the vehicle 1. The multiple criteria are set higher for a higher degree of congestion around the vehicle 1. These criteria may be set in accordance with the number or the density of people walking on a road and vehicles traveling on the road. In this example, the comparison unit 2105 first obtains the exterior image data from the storage unit 22. The comparison unit 2105 then counts the people walking on the road and the vehicles traveling on the road in the exterior image data, and determines the degree of congestion around the vehicle 1. The comparison unit 2105 compares the degree of concentration on driving with one of the criteria included in the second criterion in accordance with the degree of congestion around the vehicle 1.

The second criterion including multiple criteria set as described in accordance with the traveling state of the vehicle 1 allows the concentration determination apparatus 2 to appropriately support the driver within a dangerous area. The driver can thus safely drive the vehicle 1 while maintaining a high degree of concentration on driving, independently of the traveling state of the vehicle 1.

### Support Apparatus

### Support Operation for Driver

A support operation for the driver by the navigation apparatus 13, which is an example of the support apparatus, will be described first. The navigation apparatus 13 receives an instruction signal from the concentration determination apparatus 2. In response to the instruction signal, the navigation apparatus 13 displays an alert to the driver using an image or a video on the display 131.

A support operation for the driver performed by the sound output apparatus 16, which is an example of the support apparatus, will now be described. The sound output apparatus 16 receives an instruction signal from the concentration determination apparatus 2. In response to the instruction signal, the sound output apparatus 16 outputs an alert to the driver using a sound from the speaker 161. An alert may be in any form that can alert the driver that the driver has a low degree of concentration on driving or that the driver needs to concentrate on driving.

The driver receives the support operation from the support apparatus. This allows the driver to recognize that the driver is in a condition inappropriate for driving the vehicle 1 and refocus on driving of the vehicle 1.

### 4. ADVANTAGES AND EFFECTS

As described above, when the location of the traveling vehicle 1 is within the first area A1, the concentration determination apparatus 2 in one or more embodiments compares the degree of concentration on driving with the first criterion. When the location of the traveling vehicle 1 is within the second area A2, the concentration determination apparatus 2 compares the degree of concentration on driving with the second criterion.

The concentration determination apparatus 2 thus allows the driver to have a higher degree of concentration on driving than usual while the vehicle 1 is traveling in a dangerous area. Additionally, when the degree of concentration of the driver on driving does not satisfy the second criterion during traveling in a dangerous area, the concentration determination apparatus 2 can appropriately support the driver. Thus, the driver can safely drive the vehicle 1 while maintaining a high degree of concentration on driving during traveling in a dangerous area that takes greater concentration and attention than usual.

Further, when the current date and time is within a predetermined daytime period, the concentration determination apparatus 2 in one or more embodiments compares the degree of concentration on driving with the criterion for the predetermined daytime period included in the second criterion. When the current date and time is within a predetermined nighttime period, the concentration determination apparatus 2 compares the degree of concentration on driving with the criterion for the predetermined nighttime period included in the second criterion.

The concentration determination apparatus 2 thus allows the driver to have a higher degree of concentration on driving in the predetermined nighttime period than in the predetermined daytime period while the vehicle 1 is traveling in a dangerous area. Thus, the driver can safely drive the vehicle 1 while maintaining a high degree of concentration on driving in the night with visibility poorer than in the daytime.

Further, when the current date and time is within a weekday, the concentration determination apparatus 2 in one or more embodiments can compare the degree of concentration on driving with the criterion for weekdays included in the second criterion. When the current date and time is within any one of Saturday, Sunday, and a holiday, the concentration determination apparatus 2 can compare the degree of concentration on driving with the criterion for Saturdays, Sundays, and holidays included in the second criterion.

The concentration determination apparatus 2 thus allows the driver to have a higher degree of concentration on driving on Saturdays, Sundays, and holidays than on weekdays while the vehicle 1 is traveling in a dangerous area. Thus, the driver can safely drive the vehicle 1 while maintaining a high degree of concentration on driving on Saturdays, Sundays, and holidays with vehicle and pedestrian traffic heavier than on weekdays.

Further, the concentration determination apparatus 2 in one or more embodiments can compare one of the multiple criteria included in the second criterion with the degree of concentration on driving in accordance with the degree of congestion around the vehicle 1.

The concentration determination apparatus 2 thus allows the driver to have a degree of concentration on driving in accordance with the degree of congestion around the vehicle 1 while the vehicle 1 is traveling in a dangerous area. Thus, the driver can safely drive the vehicle 1 while maintaining a high degree of concentration on driving in the surroundings of the vehicle 1 with a higher degree of congestion.

Further, the concentration determination apparatus 2 in one or more embodiments can identify a dangerous area based on the road environment information included in the map data.

The concentration determination apparatus 2 can thus refer to the road environment information included in the map data to identify every dangerous area. Thus, the driver can safely drive the vehicle 1 in various dangerous areas while maintaining a high degree of concentration on driving.

In one or more embodiments, the dangerous areas include at least one of an area including a railroad crossing, an area including a sharp curve, an area including a junction, an area including an intersection with poor visibility, an area including a road section without a boundary marking between the sidewalk and the roadway, and an area including a road section with heavy pedestrian traffic.

The concentration determination apparatus 2 can thus identify at least one of an area including a railroad crossing, an area including a sharp curve, an area including a junction, an area including an intersection with poor visibility, an area including a road section without a boundary marking between the sidewalk and the roadway, and an area including a road section with heavy pedestrian traffic, as a dangerous area. Thus, the driver can safely drive the vehicle 1 while maintaining a high degree of concentration on driving in such an area that particularly needs safe driving.

Further, the concentration determination apparatus 2 in one or more embodiments can identify a dangerous area based on information indicating the location of a dangerous area predefined on the map data.

The concentration determination apparatus 2 can thus identify a dangerous area based on the predefined information. Thus, the driver can safely drive the vehicle 1 while maintaining a high degree of concentration on driving within an area predefined by the driver as a dangerous area.

Further, the concentration determination apparatus 2 in one or more embodiments can identify a dangerous area based on the exterior image data.

The concentration determination apparatus 2 can thus refer to the exterior image data to identify a dangerous area in real time within an area not identified in advance as a dangerous area. Thus, the driver can safely drive the vehicle 1 while maintaining a high degree of concentration on driving within a dangerous area identified in real time.

### 5. MODIFICATIONS

### 5-1. First Modification

In a first modification, the concentration determination apparatus 2 virtually divides the road into a first area A1 and a second area A2 and additionally a third area A3. The third area A3, which is different from the first area A1 and the second area A2, is defined to immediately precede the second area A2 in the traveling direction of the vehicle 1.

### Example Operation

### Operation for Estimating Degree of Concentration on Driving

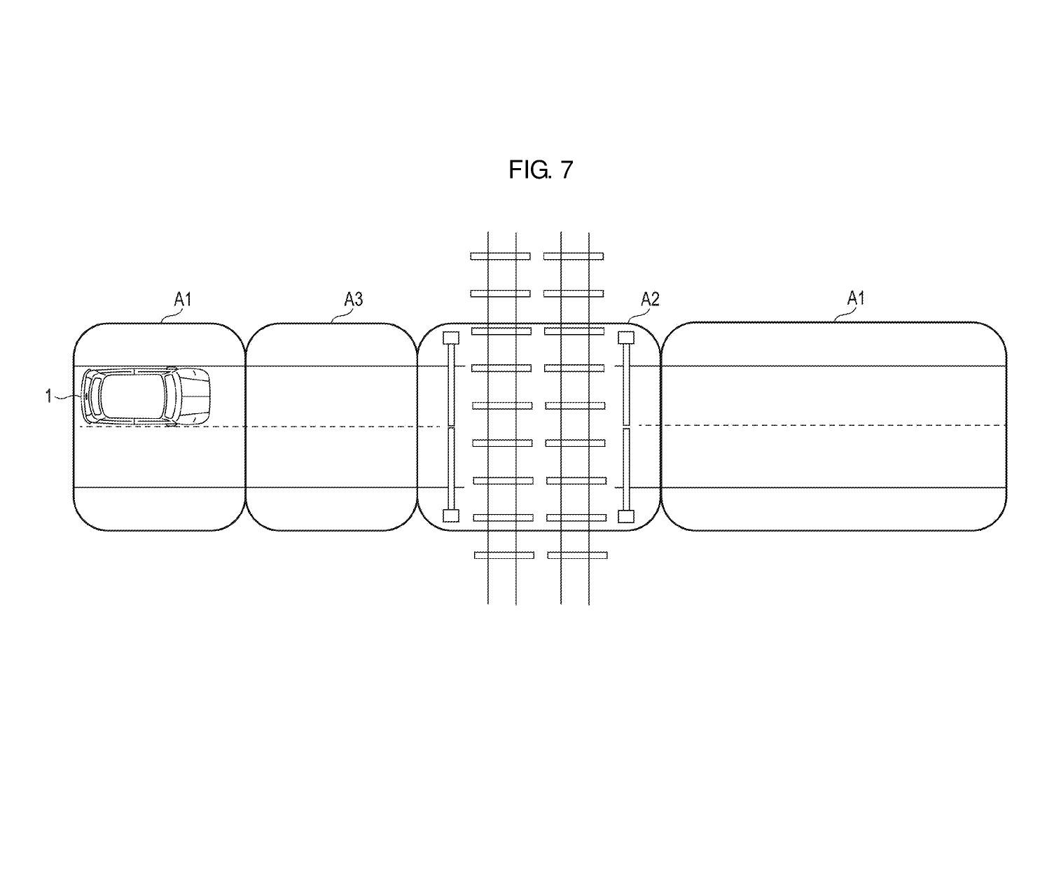

FIG. 7 is a schematic diagram showing areas for determining the degree of concentration on driving according to a first modification. The concentration determination apparatus 2 virtually divides the road to be traveled by the vehicle 1 into the first area A1, the second area A2, and the third area A3. The first area A1, the second area A2, and the third area A3 are different from one another. The second area A2 is, for example, a dangerous area such as an area including a railroad crossing. The third area A3 is an area immediately preceding the second area A2 in the traveling direction of the vehicle 1. The third area A3 may range as appropriate. The first area A1 is associated with a first criterion. The second area A2 is associated with a second criterion. The third area A3 is associated with a third criterion. The third criterion is higher than the first criterion and lower than the second criterion.

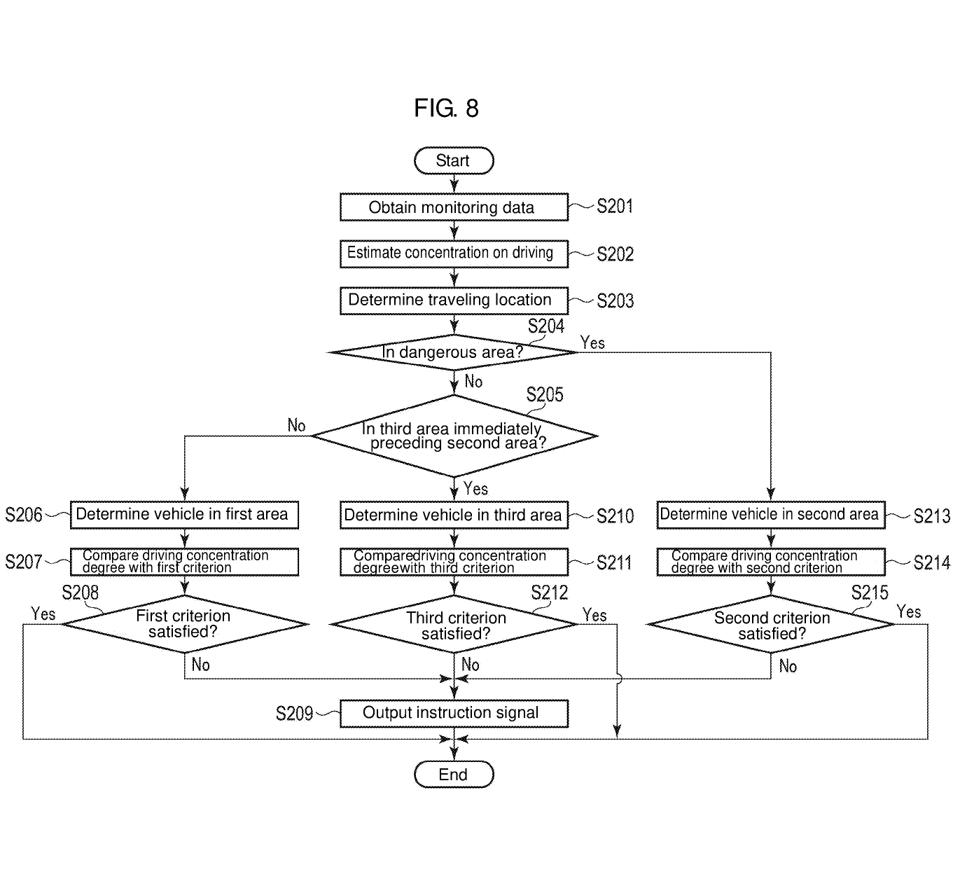

FIG. 8 is a flowchart showing an example operation for determining the degree of concentration on driving according to a first modification. The concentration determination apparatus 2 repeats the operation shown in FIG. 8 for determining the degree of concentration on driving. The concentration determination apparatus 2 may perform the operation shown in FIG. 8 for determining the degree of concentration on driving in the automatic drive mode as well as in the manual drive mode. The procedure described below is a mere example, and each of its processes may be modified. In the procedure described below, steps may be eliminated, substituted, or added as appropriate.

The processing in steps S201 through S204, steps S206 through S209, and steps S213 through S215 is the same as the processing in steps S101 through S104, steps S105 through S108, and steps S109 through S111, and will not be described. The processing in step S205 and steps S210 through S212 will now be described mainly.

The concentration determination apparatus 2 performs the processing in steps S201 through S204 in the same manner as the processing in steps S101 through S104. When the location of the traveling vehicle 1 is within the dangerous area in step S204, the concentration determination apparatus 2 performs the processing in steps S213 through S215 in the same manner as the processing in steps S109 through S111.

When the location of the traveling vehicle 1 is outside the dangerous area in step S204, the determiner 2104 determines whether the location of the traveling vehicle 1 is within the third area A3 immediately preceding the second area A2 in the traveling direction of the vehicle 1 (step S205). In step S205, the determiner 2104 refers to, for example, the map data and information indicating the location of a dangerous area to identify the third area A3. The determiner 2104 compares the current location information about the vehicle 1 with the location of the third area A3 to determine whether the location of the traveling vehicle 1 is within the third area A3.

When the location of the traveling vehicle 1 is outside the third area A3 (No in step S205), the concentration determination apparatus 2 performs the processing in steps S206 through S209 in the same manner as the processing in steps S105 through S108. When the location of the traveling vehicle 1 is within the third area A3 (Yes in step S205), the determiner 2104 determines that the location of the traveling vehicle 1 is within the third area A3 (step S210). In step S210, the determiner 2104 outputs the determination result indicating the third area A3 to the comparison unit 2105 and the output unit 2106.

The comparison unit 2105 compares the degree of concentration on driving with the third criterion (step S211). In step S212, the comparison unit 2105 compares the degree of concentration on driving with the third criterion when the location of the traveling vehicle 1 is within the third area A3. The comparison unit 2105 can compare the degree of concentration on driving with the third criterion in the same manner as in the operation for comparing the degree of concentration on driving with the first criterion or the second criterion. The comparison unit 2105 outputs the comparison result to the output unit 2106.

When the degree of concentration on driving satisfies the third criterion (Yes in step S212), the concentration determination apparatus 2 ends the operation for determining the degree of concentration on driving.

When the degree of concentration on driving does not satisfy the third criterion (No in step S212), the output unit 2106 outputs an instruction signal (step S209). More specifically, in step S209, when the location of the traveling vehicle 1 is within the third area A3 and the degree of concentration on driving does not satisfy the third criterion, the output unit 2106 outputs the instruction signal before the vehicle 1 reaches the second area A2 based on the determination result from the determiner 2104 and the comparison result from the comparison unit 2105. The concentration determination apparatus 2 ends the operation for determining the degree of concentration on driving after the instruction signal is output.

The third criterion may also include multiple criteria set in accordance with the traveling state of the vehicle 1 like the above second criterion. In this case, the comparison unit 2105 selects a criterion from the multiple criteria included in the third criterion in accordance with the traveling state of the vehicle 1, and compares the degree of concentration on driving with the selected criterion.

The third criterion including multiple criteria set as described in accordance with the traveling state of the vehicle 1 allows the concentration determination apparatus 2 to appropriately support the driver within a third area A3. The driver can thus prepare for safe driving within a dangerous area while maintaining a high degree of concentration on driving, independently of the traveling state of the vehicle 1.

### Advantages and Effects

As described above, when the location of the traveling vehicle 1 is within the third area A3 immediately preceding the second area A2 in the traveling direction of the vehicle 1, the concentration determination apparatus 2 in a first modification compares the degree of concentration on driving with the third criterion higher than the first criterion and lower than the second criterion.

The concentration determination apparatus 2 thus allows the driver to increase the degree of concentration on driving as the vehicle 1 approaches a dangerous area. Thus, the driver can maintain a higher degree of concentration on driving than usual before the vehicle 1 enters the dangerous area, and prepare for safe driving within the dangerous area.

### 5-2. Second Modification

The concentration determination apparatus 2 estimates the degree of concentration on driving based on, but not limited to, the driver image data that is an example of monitoring data. The monitoring data may be, for example, vital sign data obtained by a vital sign sensor monitoring the driver of the vehicle 1. The vital sign sensor is, for example, a pulse wave sensor or a heartbeat sensor. The vital sign sensor may be any other sensor monitoring the driver. The vital sign sensor may be a contact sensor or a contactless sensor. The concentration determination apparatus 2 can detect the driver's conditions based on the vital sign data. The driver's conditions detected from the vital sign data are, for example, indicators such as pulse waves or heartbeats. The monitoring data may be, for example, data obtained by a sensor attached to the steering wheel 5 and measuring the tightness of the driver's grip on the steering wheel 5.

### 5-3. Modification 3

The present invention is not limited to one or more embodiments described above, but the components may be modified without departing from the spirit and scope of the invention. The components described in one or more embodiments may be combined as appropriate to provide various aspects of the invention. For example, some of the components described in one or more embodiments may be eliminated. Further, components in one or more embodiments may be combined as appropriate.

### 6. APPENDIX

One or more embodiments may be partially or entirely expressed in, but not limited to, the following forms shown in the appendix below in addition to the claims.

### Appendix

A concentration determination apparatus (2), comprising:

a monitoring data obtaining unit (2101a) configured to obtain monitoring data about a driver of a vehicle (1);

an estimation unit (2102) configured to estimate a degree of concentration of the driver on driving based on the monitoring data;

a determiner (2104) configured to determine whether a location of the vehicle (1) traveling is within a dangerous area;

a comparison unit (2105) configured to compare the degree of concentration on driving with a first criterion when the location of the traveling vehicle (1) is within a first area different from the dangerous area, and compare the degree of concentration on driving with a second criterion higher than the first criterion when the location of the traveling vehicle (1) is within a second area corresponding to the dangerous area; and

an output unit (2106) configured to output an instruction signal for supporting the driver when the location of the traveling vehicle (1) is within the second area and the degree of concentration on driving does not satisfy the second criterion based on a determination result from the determiner (2104) and a comparison result from the comparison unit (2105).

1. A concentration determination apparatus, comprising a processor configured with a program to perform operations comprising:
operation as a monitoring data obtaining unit configured to obtain monitoring data about a driver of a vehicle;
operation as an estimation unit configured to estimate a degree of concentration of the driver on driving based on the monitoring data;
operation as a determiner configured to determine whether a location of the traveling vehicle is within a dangerous area;
operation as a comparison unit configured to compare the degree of concentration on driving with a first criterion when the location of the traveling vehicle is within a first area different from the dangerous area, and compare the degree of concentration on driving with a second criterion higher than the first criterion when the location of the traveling vehicle is within a second area corresponding to the dangerous area; and
operation an output unit configured to output an instruction signal for supporting the driver when the location of the traveling vehicle is within the second area and the degree of concentration on driving does not satisfy the second criterion based on a determination result from the determiner and a comparison result from the comparison unit.

2. The concentration determination apparatus according to claim 1, wherein
when the location of the traveling vehicle is within a third area immediately preceding the second area in a traveling direction of the vehicle, the processor is configured to perform operations such that the comparison unit compares the degree of concentration on driving with a third criterion higher than the first criterion and lower than the second criterion, and
when the location of the traveling vehicle is within the third area and the degree of concentration on driving does not satisfy the third criterion, the processor is configured to perform operations such that the output unit outputs the instruction signal before the vehicle reaches the second area.

3. The concentration determination apparatus according to claim 1, wherein
the second criterion includes a criterion for a predetermined daytime period and a criterion for a predetermined nighttime period higher than the criterion for the predetermined daytime period, and
the processor is configured to perform operations such that the comparison unit compares the degree of concentration on driving with the criterion for the predetermined daytime period when a current date and time is within the predetermined daytime period, and compares the degree of concentration on driving with the criterion for the predetermined nighttime period when the current date and time is within the predetermined nighttime period.

4. The concentration determination apparatus according to claim 1, wherein
the second criterion includes a criterion for weekdays and a criterion for Saturdays, Sundays, and holidays higher than the criterion for weekdays, and
the processor is configured to perform operations such that the comparison unit compares the degree of concentration on driving with the criterion for weekdays when a current date and time is within a weekday, and compares the degree of concentration on driving with the criterion for Saturdays, Sundays, and holidays when the current date and time is within any one of Saturday, Sunday, and a holiday.

5. The concentration determination apparatus according to claim 1, wherein
the second criterion includes a plurality of criteria for degrees of congestion around the vehicle, and
the processor is configured to perform operations such that the comparison unit compares the degree of concentration on driving with one of the criteria included in the second criterion in accordance with a degree of congestion around the vehicle.

6. The concentration determination apparatus according to claim 1, the processor is configured with the program to perform operations further comprising:
operation as a map data obtaining unit configured to obtain map data including road environment information; and
operation as an identification unit configured to identify the dangerous area based on the road environment information included in the map data.

7. The concentration determination apparatus according to claim 6, wherein
the dangerous area includes at least one of an area including a railroad crossing, an area including a sharp curve, an area including a junction, an area including an intersection with poor visibility, an area including a road section without a boundary marking between a sidewalk and a roadway, and an area including a road section with heavy pedestrian traffic.

8. The concentration determination apparatus according to claim 1, the processor is configured with the program to perform operations further comprising:
operation as a map data obtaining unit configured to obtain map data including predefined information indicating a location of the dangerous area; and
operation as an identification unit configured to identify the dangerous area based on the information included in the map data and indicating the location of the dangerous area.

9. The concentration determination apparatus according to claim 1, the processor is configured with the program to perform operations further comprising:
operation as an exterior image data obtaining unit configured to obtain exterior image data representing a captured exterior view from the vehicle; and
operation as an identification unit configured to identify the dangerous area based on the exterior image data.

10. The concentration determination apparatus according to claim 1, wherein
the second criterion includes a criterion for a predetermined daytime period and a criterion for a predetermined nighttime period higher than the criterion for the predetermined daytime period, and
the processor is configured to perform operations such that the comparison unit compares the degree of concentration on driving with the criterion for the predetermined daytime period when a current date and time is within the predetermined daytime period, and compares the degree of concentration on driving with the criterion for the predetermined nighttime period when the current date and time is within the predetermined nighttime period.

11. The concentration determination apparatus according to claim 2, wherein
the second criterion includes a criterion for weekdays and a criterion for Saturdays, Sundays, and holidays higher than the criterion for weekdays, and
the processor is configured to perform operations such that the comparison unit compares the degree of concentration on driving with the criterion for weekdays when a current date and time is within a weekday, and compares the degree of concentration on driving with the criterion for Saturdays, Sundays, and holidays when the current date and time is within any one of Saturday, Sunday, and a holiday.

12. The concentration determination apparatus according to claim 2, wherein
the second criterion includes a plurality of criteria for degrees of congestion around the vehicle, and
the processor is configured to perform operations such that the comparison unit compares the degree of concentration on driving with one of the criteria included in the second criterion in accordance with a degree of congestion around the vehicle.

13. The concentration determination apparatus according to claim 2, the processor is configured with the program to perform operations further comprising:
operation as a map data obtaining unit configured to obtain map data including road environment information; and
operation as an identification unit configured to identify the dangerous area based on the road environment information included in the map data.

14. A concentration determination method, comprising:
obtaining monitoring data about a driver of a vehicle;
estimating a degree of concentration of the driver on driving based on the monitoring data;
determining whether a location of the traveling vehicle is within a dangerous area;
comparing the degree of concentration on driving with a first criterion when the location of the traveling vehicle is within a first area different from the dangerous area, and comparing the degree of concentration on driving with a second criterion higher than the first criterion when the location of the traveling vehicle is within a second area corresponding to the dangerous area; and
outputting an instruction signal for supporting the driver when the location of the traveling vehicle is within the second area and the concentration degree does not satisfy the second criterion.

15. A non-transitory computer-readable recording medium storing a program for concentration determination causing a computer to perform operations as the units included in the concentration determination apparatus according to claim 1.
